(19) United States
(12) Patent Application Publication
(10) Pub. No.: US 2007/0198100 A1
(43) Pub. Date: Aug. 23, 2007

(54) HYBRID FIELD DEVICE CABLING WITH INDUSTRIAL NETWORK AND OPERATING POWER

(75) Inventors: Brian E. Butters, London, ON (CA); Anthony L. Powell, London, ON (CA); John D. Pearce, London, ON (CA); Matthew Brian Frederick Murdock, London, ON (CA)

Correspondence Address: BAKER & MCKENZIE LLP;PATENT DEPARTMENT, 2001 ROSS AVENUE, SUITE 2300, DALLAS, TX, 75201, US

(73) Assignee: PURIFICS ENVIRONMENTAL TECHNOLOGIES, INC., London (CA)

(21) Appl. No.: 11/539,197

(22) Filed: Oct. 6, 2006

Related U.S. Application Data
(60) Provisional application No. 60/724,048, filed on Oct. 6, 2005.

(51) Int. Cl. G05B 11/01

(52) U.S. Cl. 700/19; 307/1; 174/113 R; 340/3.43; 700/21

(57) ABSTRACT

The disclosed principles provide for a digital industrial network and related method of maintaining and operating a system. An industrial network constructed according to the disclosed principles combines both the control/data signals used with smart control devices and operating power for those devices in one industrial network hybrid cable. In one embodiment, an industrial network comprises smart control devices for maintaining and operating a system, and hybrid cabling connecting the smart control devices in a daisy-chain. In addition, in such an industrial network, the cabling is configured to transmit control/data signals and operating power for the smart control devices along the daisy-chain.

### CROSS- REFERENCE TO RELATED APPLICATION

This application claims the benefit of U.S. Provisional Application Ser. No. 60/724,048, filed on Oct. 6, 2005, and entitled “Hybrid Field Device Cabling with Industrial Network and Operating Power,” commonly assigned with the present application and incorporated herein by reference for all purposes.

### TECHNICAL FIELD

Disclosed embodiments herein relate generally to industrial networks, and more particularly to a hybrid cabling device and associated digital industrial network combining sub-addressable control/data signals and the power supply for the smart devices.

### BACKGROUND

Several technologies for treating contaminated media, such as waste water, are available on the open market today, and have continued to gain wide-spread desirability in today's more environmentally conscious world. For the proper monitoring and operating of such decontamination systems, multiple control devices are typically employed to provide feedback on all aspects of the system. To control and monitor such system devices, such as sensors, valves, etc., “industrial networks” have been developed to send control signals to these devices, as well as to receive data signals back from them. The data and control information refers to signals used to control the action of motors or positioners, etc. in such decontamination systems (or their associated plumbing).

In industrial systems, there are typically a number of ways to pull sensor data back or to send control information to the sensors. Thus, these signals result in electrical, or electronic, control of such system equipment. Exemplary control devices include pumps, valves, sensors, etc., all of which operate on DC control signals of about 0V-10V to drive the device within its operating span. The actual position or command output would fall somewhere within that span, and thus correspond to the span of operation of either the sensor or controller. In other conventional embodiments, a range of 4 to 20 milliamp current signals is employed. In such systems, current has the advantage of being a less susceptible to electrical resistance so it may be run over long distances. Moreover, current data/control signals are less susceptible to voltage interference or magnetic interference.

In more recent years, there have been several attempts to create digital busses for sending/receiving such data/control signals. In these attempts, instead of sending analog signals for analog devices, digital signals, with all of the advantages of digital signals in terms of magnetic interference resistance, increased accuracy, etc., would be sent/received. Key advantages over the analog signals are that digital signals are not prone to resistance losses or to current drops. For example, in analog systems, the signal cable itself used to send/receive analog signals causes the resistance, which may result in signal error. Therefore, the longer the cable is, the more resistance will be present. Thus, digital systems overcome this potential error because when a digital number is transmitted as data, what is received is the same digital number.

Because of the advantages of digital data/control signals, the market is accordingly moving in this direction. As a result, there are a number of conventional digital networks available for this type of application, and they are becoming faster and can handle increased data with each iteration. Specifically, more modern systems now include diagnostic information for “smart systems.” For example, in a smart system incorporating a pressure sensor, rather then merely transmitting data regarding the measured pressure, a “smart device” may be configured to transmit diagnostic information as well. Examples of such diagnostic information include configuring an alarm limit if the pressure reaches greater than some threshold. It may also transmit information regarding device calibration, whether a sensor has gone off-line, types of error, or even whether an invalid input has been sent to the device and the device cannot process that data.

The most popular digital industrial networks employing such smart devices operates on the fieldbus protocol known as the ProfiBus, developed in 1989 by an international consortium of companies and institutions. One particular ProfiBus-based network is a network having control devices operating with the ProfiBus-DP protocol, used for driving these process devices (DP). This particular industrial network can provide high-speed data rates of 1 megabit to 12 megabits per second. As a result, large amounts of diagnostics information may be transmitted to/from smart devices on such an industrial network. Most of these types of networks are two-wire systems, and are thus like a serial data system. Moreover, there are different protocols that may run on a cable in such a digital network. Another example of a multi-protocol digital network is ProfiNet, which runs an industrial network on top of an Ethernet cable. Other exemplary protocols for industrial networks include DeviceNet and Foundation Fieldbus.

Among conventional digital industrial networks, control signals may also now be routed from smart device to smart device in a “daisy-chain” method, rather than by individually dedicating cables for each control device. As a result, control wiring is reduced and installation is simplified due to fewer cables. However, these networks, for example, having devices operating with the ProfiBus-DP protocol mentioned above, still require external power (e.g., 24VDC) for each of the smart control devices, requiring an additional cable for each distinct smart device. Thus, although one bus cleanly daisy-chains the length of the network, separate power supply cables for each control device is still required.

In a few modern conventional industrial networks, in addition to transmitting control/data signals to/from system control devices, the power to operate the control devices is provided on the same cable. An example of this type of industrial network is one having control devices that operate with the ProfiBus-PA protocol, which is for process automation (PA) via the control devices. However, with this type of network, while the power supply may be daisy-chained from control device to control device, only the binary data signals associated with “dumb” or “semi-smart” control devices are also able to be to daisy-chained. Thus, the daisy-chaining of control/data signals and the power supply for the most advanced smart devices, for example, that communicate in a specific protocol involving sub-addressable data, is not provided.

### SUMMARY

The disclosed principles provide for a digital industrial network and related method of maintaining and operating a system. An industrial network constructed according to the disclosed principles combines both the control/data signals used with smart control devices and operating power for those devices in one industrial network hybrid cable. The smart control devices Are sensors, cabling, and other network items that function on, employ, and communicate in a specific protocol of control/data signals that include “sub-addressable” data, such as diagnostic data/information provided by a smart device in response to a query of addressable data.

In one aspect, an industrial network is provided. In one embodiment, the industrial network comprises smart control devices for maintaining and operating a system, and hybrid cabling connecting the smart control devices in a daisy-chain. In addition, in such an industrial network, the cabling is configured to transmit control/data signals and operating power for the smart control devices along the daisy-chain.

In another aspect, a method of maintaining and operating a system is provided. In one embodiment, the method comprises providing smart control devices at select points in the system. In addition, the method provides interconnecting the smart control devices in a daisy-chain fashion. Moreover, in such embodiments, the method further comprises transmitting control/data signals and operating power for the smart control devices along the daisy-chain using a hybrid cabling providing the interconnecting.

### BRIEF DESCRIPTION OF THE DRAWINGS

For a more complete understanding of this disclosure, and the advantages of the systems and methods herein, reference is now made to the following descriptions taken in conjunction with the accompanying drawings, in which:

FIG. 1 illustrates a schematic diagram of a digital industrial network 100 constructed according to the disclosed principles.

### DETAILED DESCRIPTION

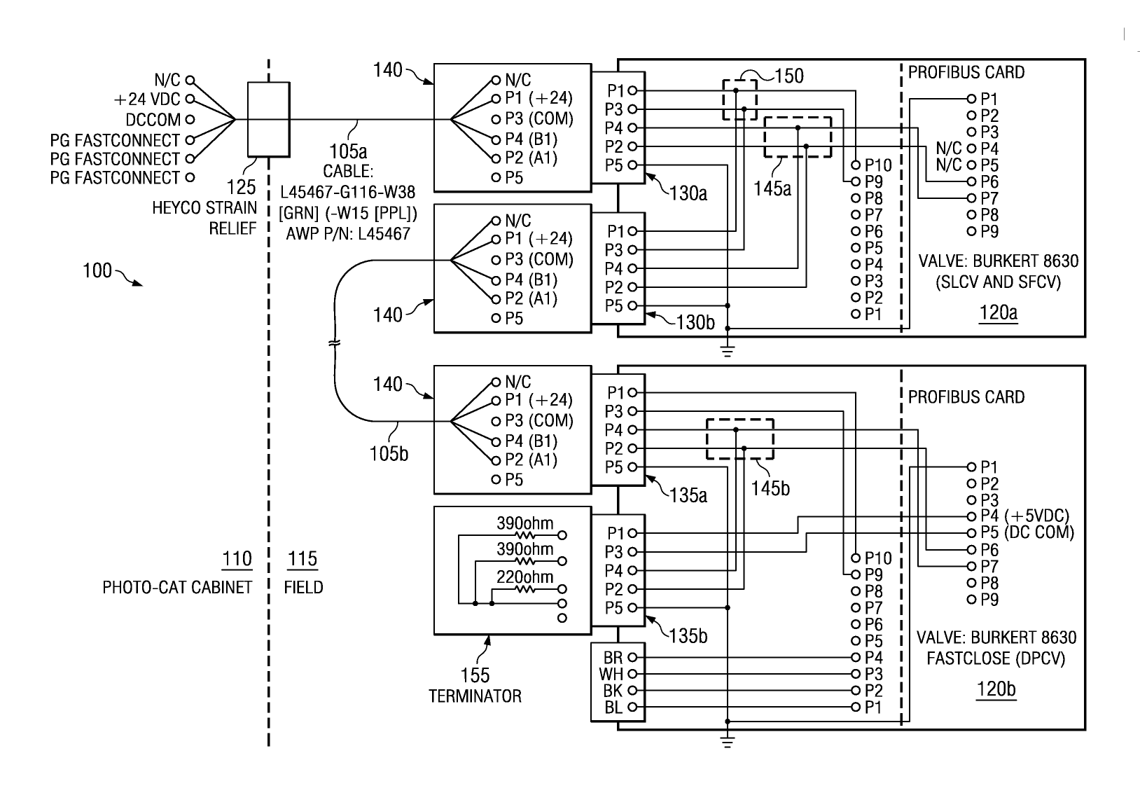

Referring to FIG. 1, illustrated is a schematic diagram of a digital industrial network 100 constructed according to the disclosed principles. This exemplary network 100 combines both the control/data signals used with smart devices and operating power for those devices in one industrial network cable. As mentioned above, the disclosed control/data signals are for use with smart devices such as the “smart sensors” shown in FIG. 1. It should be noted that although a ProfiBus smart valve is illustrated in FIG. 1, a network constructed according to the disclosed principles may employ any type of smart device with the same advantages as described herein.

As used herein, the term “smart” when used in conjunction with “sensor,” “valve,” or other type of industrial network control device means devices, cabling, and other network items that function on, employ, and communicate in a specific protocol of control/data signals that include “sub-addressable” data, such as diagnostic data/information provided by a smart device in response to a query of addressable data. These would include both single value and multi-value control/data signals, as well as multiple data types, for smart devices. For example, the “smart” devices that operate on a ProfiBus-DP protocol network would be considered the type of smart devices employable with the disclosed network; however, the “semi-smart” control devices employed with the ProfiBus-PA network would not qualify.

Such smart devices have embedded logic circuits and thus have independent computing power. This makes them independently programmable and operable, yet are still able to be integrated into industrial systems. An analogy to these smart devices and their operation in industrial networks can be made to home computers and web servers. Each home computer, like the defined smart devices, can function completely independently of a network. However, by connecting them to the network, monitoring and interaction of their processes is also possible.

Network devices not considered “smart” (e.g., so-called “dumb” devices) typically communicate in binary signals such as those used by a single value device. Examples of binary signals are discrete single values, for example, a yes/no value, an on/off value, a true/false value, etc. In this sense, a single value device simply tells the controller where the device is and its span (e.g., position), or allows the controller to command the device to be in a certain span. In contrast, a multi-value device not only does the same things as a single value device, but also has multiple spans that may have triggers for certain operating modes, and it may have triggers for telling the controller what fault conditions exist within it, etc. The higher end “smart” devices that are a basis of the disclosed network have what may be referred to as “addressable data” and “sub-addressable data.” Addressable data means that a specific device, such as a sensor or a valve, may be individually addressable among the multiple devices within a single industrial network. Advanced digital industrial networks assign an address to every device (e.g., sensor, valve, etc.). An analogy of this “addressing” may be made to the Internet, where every device that's on the Internet has one address.

In addition, each addressable device may also be subdivided so that it is sub-addressable. Hence, sub-addressable data means that multiple types of data, or data fields may be queried from each addressable smart device. For example, if an operator wants to know Value 2 and Value 5 for a specific device, he can query that device to ask for those values. Such a query could include the operating state of the device along with diagnostic information concerning that device. Thus, such smart devices may provide not only multiple values, but different kinds of data in response to a query. As such, smart devices may be instructed with a desired result, and the logic therein (e.g., a microprocessor) determines how to achieve that result. Moreover, the achievement of that result, as well as the means by which the result is achieved by the device, may be monitored and otherwise queried. With non-smart devices, the operator would query the device, but would only receive back a binary value in response, such as that a valve is on or off. Accordingly, while such sub-addressable querying of smart devices is available, a network constructed according to the disclosed principles provides this sub-addressing “smart” capability among daisy-chained smart devices, along with a daisy-chaining of the power supply for those smart devices.

As shown in FIG. 1, the cables 105a, 105b employed in systems constructed as disclosed herein are an “off-the-shelf” cable typically employed with smart industrial networks. Of course, although one particular commercially available cable 105a, 105b is illustrated, it should be under stood that any comparable cable may be employed. Specifically, the cabling 105a, 105b selected for use with the disclosed network 100 combines both the digital network control/data signals (e.g., “PG FASTCONNECT”) and the DC power supply (e.g., “+24VDC” and “DCCOM”) to operate the smart devices, as well as providing the shielding and grounding of these lines all in one cable 105a, 105b.

In the illustrated embodiment, two cables 105a, 105b are shown. One cable 105a is shown connecting the control/data and power signals to/from a control area 110 (e.g., a Photo-Catalytic System Control Cabinet) to the field area 115 where two smart devices 120a, 120b are in use. If desired, a strain relief device 125 may be employed for the cable 105a bridging the control area 110 and the field 115, but this is not required. As before, although the network 100 illustrates two ProfiBus smart valves, any comparable smart device may also be employed. The second cable 105b is illustrated coupling the first device 120a to the second device 120b in a daisy-chain fashion.

In accordance with the disclosed principles, the second cable 105b is used to couple both the control/data signals of, and the operational power supply for, the first and second smart devices 120a, 120b in a daisy-chain fashion. To accomplish the daisy-chaining of both the control/data signals and the power supply, the internal wiring of the control devices 120a, 120b is selected such that the control/data signals are parallel-coupled between the inputs 130a, 130b and the outputs 135a, 135b of the control devices 120a, 120b, respectively. Specifically, connectors 140 of the cables 105a, 105b include pins corresponding to pins in the inputs 130a, 130b and outputs 135a, 135b of the control devices 120a, 120b. However, while the cabling 105a, 105b itself may be conventionally available, it should be noted that the connectors 140 used with the cables 105a, 105b are not. More specifically, the connectors 140 are selected or manufactured in accordance with the disclosed principles so as to have the minimum number of pins needed to transmit in a daisy-chained fashion the control/data signals for the smart control devices 120a, 120b, as well as the power supply signal for those devices 120a, 120b. As discussed above, while some conventional networks may have cabling (and thus connectors) for transmitting data signals and power supply, those cables and connectors are again only for dumb or semi-smart devices, and would not work for the smart devices disclosed in the present network 100.

In the illustrated embodiment, pins P1 and P3 provide the power supply to the control devices 120a, 120b, while the remaining pins (P1, P2, P4, P5, in this example) may be used to send or receive the control/data signals. The parallel coupling of the pines or terminals for the control/data signals is illustrated in areas 145a, 145b for respective control devices 120a, 120b. As discussed above, the parallel coupling of the pins transmitting the control/data signals so that a series of cables (e.g., 105a, 105b, etc.) may be used to daisy-chain connect the control devices 120a, 120b is available in some advanced industrial networks. In addition to this, however, the pins or terminals used for supplying voltage to the control devices 120a, 120b are also parallel coupled in the disclosed network 100, which is shown in area 150. This parallel coupling of power lines inside of control device 120a allows the power input through its input 130a to be used by the control device 120a, and also sent to its output 130b. The second cable 105b may then transmit the power signal at its output 130b to the input 135a of the second control device 120b, thus daisy-chaining the power supply to the control devices 120a, 120b along with the daisy-chaining of the control/data signals.

In the illustrated embodiment, the power supply is not further tapped off of the input 135a of the second control device 120b, and then provided at its output 135b, but it may be if desired. More specifically, the embodiment of the network 100 shown in FIG. 1 provides only two control devices 120a, 120b daisy-chained together, however, any number of control devices may be so-connected in accordance with the disclosed principles. As shown here, when the last control device 120b in the daisy-chain has been reached, a terminator 155 or other type of bus terminating device may be connected to the last control devices' 120b output 135b. The terminator 155 is employed at the end of the bus, or at the end of the digital network, and it includes resistors that prevent signals from feeding back into the digital network.

In order to provide the parallel connection from one control devices' 120a input 130a to its output 130b so that the power, along with the control/data signals, may be daisy-chained to the next control device 120b, a new smart control device having this type of electrical connection may be constructed. In other embodiments, such as the embodiment illustrated in FIG. 1, a previously existing smart control device 120a, such as a ProfiBus “smart valve,” may be modified to provided the needed parallel power connections. In either embodiment, the disclosed principles provide a distinct advantage over conventionally available smart industrial networks by allowing the daisy-chaining of both the control/data signals and the power signals. This eliminates the dedicated power cables for each control device required in conventional networks. As a result, the overall complexity of the installed industrial network is reduced, by reducing the number of cables needed. In addition, by reducing the complexity of the network in this manner, the overall expense of the industrial network is correspondingly reduced.

Other variations in the embodiments of a system constructed according to the disclosed principles are also envisioned. For example, in some embodiments, the network 100 is a ProfiBus-DP industrial network, however, in accordance with the above discussion, the control devices 120a, 120b have been modified so that both the sub-addressable control/data signals and the operating power to the control devices may be daisy-chained through the ProfiBus-DP cabling. In such embodiments, the cabling 105a, 105b uses standard compact and waterproof 5-pole, M12 pin layout connectors, but of course any appropriate cabling may be used. In other, smaller variations, the power supplied to the control devices 120a, 120b is 24VDC, however, it is understood that various amounts of power may be supplied to the control devices 120a, 120b. Also, while the illustrated network 100 is operating on a UV photocatalytic reactor, it is understood that an industrial network constructed as disclosed herein may be employed with any appropriate systems.

While various embodiments of the disclosed principles have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. An industrial network, comprising:
smart control devices for maintaining and operating a system; and
hybrid cabling connecting the smart control devices in a daisy-chain, the cabling configured to transmit control/data signals and operating power for the smart control devices along the daisy-chain.

2. An industrial network according to claim 1, wherein operating power input to each smart control device via the hybrid cabling is parallel-coupled to output to the hybrid cabling from each smart control device.

3. An industrial network according to claim 2, wherein wiring inside each smart control device for carrying each device's operating power is parallel-coupled across the device's input and output.

4. An industrial network according to claim 1, wherein the smart control devices are selected from the group consisting of pumps, valves, and sensors.

5. An industrial network according to claim 1, wherein the operating power is about 24VDC.

6. An industrial network according to claim 1, wherein the control/data signals comprise about 0V-10V signals.

7. An industrial network according to claim 1, wherein the control/data signals comprise at least one selected from the group consisting of a single value, multiple values, and multiple data types.

8. An industrial network according to claim 1, wherein the control/data signals of the smart control devices comprise sub-addressable data selected from the group consisting of diagnostic data associated with a smart control device, operating mode associated with a smart control device, fault conditions existing within a smart control device, operational state of a smart control device, and position of smart control device.

9. An industrial network according to claim 1, wherein the system is a UV photo-catalytic decontamination system.

10. An industrial network according to claim 1, wherein the hybrid cabling comprises 5-pole, M12 pin layout connectors coupling the hybrid cabling to the smart control devices.

11. A method of maintaining and operating a system, the method comprising:
providing smart control devices at select points in the system; and
interconnecting the smart control devices in a daisy-chain; and
transmitting control/data signals and operating power for the smart control devices along the daisy-chain using a hybrid cabling providing the interconnecting.

12. A method according to claim 11, wherein transmitting operating power comprises 5 inputting operating power to each smart control device, and parallel-coupling the input operating power for output to the hybrid cabling from each smart control device.

13. A method according to claim 12, wherein wiring inside each smart control device for carrying each device's operating power is parallel-coupled across the device's input and output.

14. A method according to claim 11, wherein the smart control devices are selected from the group consisting of pumps, valves, and sensors.

15. A method according to claim 11, wherein transmitting operating power comprises transmitting operating power of about 24VDC.

16. A method according to claim 11, wherein transmitting control/data signals comprises transmitting control/data signals of about 0V-10V.

17. A method according to claim 11, wherein the control/data signals comprise at least one selected from the group consisting of a single value, multiple values, and multiple data types.

18. A method according to claim 11, wherein the control/data signals of the smart control devices comprise sub-addressable data selected from the group consisting of diagnostic data associated with a smart control device, operating mode associated with a smart control device, fault conditions existing within a smart control device, operational state of a smart control device, and position of smart control device.

19. A method according to claim 11, wherein the system is a UV photo-catalytic decontamination system.

20. A method according to claim 11, wherein transmitting using a hybrid cabling comprises transmitting using a hybrid cabling having 5-pole, M12 pin layout connectors for coupling the hybrid cabling to the smart control devices.
